(19) United States
(12) Patent Application Publication
(10) Pub. No.: US 2008/0160297 A1
(43) Pub. Date: Jul. 3, 2008

(54) Workpiece Comprising Detachable Optical Products and Method for Manufacturing the Same

(75) Inventor: Jari Ruuttu, Billnas (FI)

Correspondence Address: YOUNG & THOMPSON, 209 Madison Street, Suite 500, ALEXANDRIA, VA, 22314, US

(73) Assignee: PINTAVISION OY, HELSINKI (FI)

(21) Appl. No.: 11/884,865

(22) PCT Filed: Feb. 23, 2006
(86) PCT No.: PCT/FI2006/000064

§ 371 Date: Sep. 13, 2007

(30) Foreign Application Priority Data
Feb. 23, 2005 (FI) 20050216
Feb. 23, 2005 (FI) 20050218
Nov. 5, 2005 (FI) 20051120

(51) Int. Cl. B32B 33/00; C23C 20/00

(52) U.S. Cl. 428/336; 428/409; 428/408; 427/554

(57) ABSTRACT

The invention relates to a method for producing a workpiece comprising one or more detachable optical products and to a preferably planar workpiece comprising detachable optical products. The method of the invention allows for efficient production of workpieces comprising high-quality optical lenses by combining e.g. techniques used in the production of CD/DVD discs and coating units based on laser ablation. The finished optical products are integrated in the workpiece, but they can be removed e.g. by water abrasion, laser cutting, milling or sawing.

### FIELD OF THE INVENTION

This invention relates to a new workpiece comprising detachable optical products and to a method for manufacturing the same. The invention allows for inexpensive manufacture of anti-scratch, high-quality optical products that may comprise even a plurality of functional coatings.

### STATE OF THE ART

FI Patent Application 20020239 describes manufacture and working of a plurality of optical products, with the steps for working the optical products comprised in the same workpiece carried out substantially in the same work step each time. The workpiece and the optical products are made of the same material and the optical products have been formed as an integrated part of the workpiece, with the optical products connected to the inner and outer circumference of the workpiece by means of projections. Due to the projecting structures, the optical products are poorly attached to the workpiece. Consequently, it is difficult to perform further processing of optical products attached by projecting structures, since separate apparatus settings would be required for each projection structure system during the coating steps, for instance. In addition, the injection-moulding process of the optical products themselves is performed via these narrow projections. This involves an increased risk of obstruction and impairs the quality of the end products.

FI Patent Application 20050218 depicts workpieces containing optical products, from which the optical products are detached by forming an angular edge on the optical product. FI Patent Application 20050216 depicts e.g. the formation of diamond and metal oxide plates on plastic and glass surfaces by using pulsed laser.

CD/DVD discs can be produced using a plurality of different installations. A number of such installations and/or their parts have been described e.g. in US Patent Application 2002/0067978 and SE patents 513370 and 513733.

### SUMMARY OF THE INVENTION

Solutions currently available on the market for producing optical products do not enable integrated manufacture of high-quality, especially scratch-resistant and antireflective lenses or screen shields with a plurality of optical product blanks produced in one single work step and these blanks analogously coated with one or more plates as required in each case, with all the optical products in the workpiece being coated in one single work step.

The object of this invention is a workpiece comprising one or more detachable optical products. Such a workpiece comprising an optical product integrated without seams has been coated with one or more plates so that the hardness of at least the uppermost coating of the coated workpiece is at least 2 on the Mohs scale of hardness. The optical products of the invention are preferably planar, but they may also be three-dimensional. The finished optical products can easily be detached by cutting from the workpiece by means of known methods in the step most expedient in each case.

This invention also has the object of providing a method for producing a workpiece comprising one or more detachable optical products.

The invention that has now been conceived is based on the surprising observation that high-quality, especially planar optical products can be produced economically and rapidly by manufacturing, in a single operation, a workpiece comprising a plurality of optical products and by subjecting it to further processing so that the different coatings and functions to be provided on the surface of the workpiece can each be produced in one single work step. In this manner, the optical products comprised in the workpiece will receive the same functions and coatings in one single work step without the risk of contamination (dirt).

The production lines of CD/DVD discs that are already available on the market represent one particularly advantageous installation for manufacturing such workpieces. The workpiece can be injection-moulded in the injection-moulding unit of the installation, and part of the coatings can be produced in surface-treatment units included in the installation. The production of some special coatings may require the use of coatings produced by laser ablation. Such laser installations can readily be integrated in the CD/DVD disc production lines that are already available on the market. Although the workpiece of the invention is produced by using such previously known production lines, the shape and the thickness of the workpiece produced by these installations are not confined to those that have been produced in products so far. Thus, for instance, a CD/DVD disc has a diameter of 120 mm. In accordance with the invention, the size of the workpiece is preferably increased so that the workpiece can accommodate a maximum number of optical products. Consequently, the workpiece of one embodiment of the invention is circular with a diameter of 170 mm.

### FIGURES

FIG. 1. A prior art injection-moulding installation (Netstal E-Jet).

FIG. 2. A prior art coating unit (M2 SQ1).

FIG. 3. An embodiment of the invention for producing a planar workpiece comprising detachable optical products. The workpiece has the same size as an ordinary CD/DVD disc, i.e. a diameter of 120 mm.

FIG. 4. A workpiece of the invention comprising optical products, with the points of detachment of the optical products marked. The workpiece has the size of an ordinary CD/DVD disc, i.e. a diameter of 120 mm.

FIG. 5. An embodiment of the invention for producing a planar workpiece comprising detachable optical products. The workpiece resembles an ordinary CD/DVD disc, but its diameter is 170 mm.

FIG. 6. Illustration of Light Guide Plates LGP on a workpiece of the invention and their operation principle. The LGP directs light incident on a lens or a screen shield so that a minimum portion of the light reaches the actual display.

FIG. 7. One surface solution for the optical product (lens) in the planar workpiece of the invention. The actual lens (1) (optionally the screen shield) has an LGP plate previously produced either by injection moulding or lamination. The lower and upper faces of the lens are coated with a lacquer coating (2). The lacquer preferably consists of hard lacquer.

FIG. 8. One surface solution for the optical product in the planar workpiece of the invention. The actual lens (1) (optionally the screen shield) has an LGP plate already produced either by injection moulding or lamination. The lacquer surface (2) is provided only on the lower face of the lens.

FIG. 9. One surface solution of the optical product in the planar workpiece of the invention. The actual lens (1) (optionally the screen shield) has an LGP plate previously produced either by injection moulding or lamination. The lacquer surface (2) is provided only on the upper face of the lens.

FIG. 10. One surface solution of the optical product in the planar workpiece of the invention. The actual lens (1) (optionally the screen shield) has an LGP plate previously produced either by injection moulding or lamination. The lower and upper faces of the lens are coated with a lacquer coating (2). In this embodiment, the uppermost coating of the optical product is a diamond plate (3).

FIG. 11. One surface solution of the optical product in the planar workpiece of the invention. The actual lens (1) (optionally the screen shield) has an LGP plate previously produced either by injection moulding or lamination. The lower face of the lens has a lacquer coating (2) and the upper face is coated with a diamond plate (3).

FIG. 12. One surface solution of the optical product in the planar workpiece of the invention. The lens (4) (optionally the screen shield) of this embodiment has no LGP plate. The upper face of the lens is coated with a diamond plate (3).

FIG. 13. One surface solution of the optical product in the planar workpiece of the invention. The actual lens (5) (optionally the screen shield) has LGP plates previously produced either by injection moulding or lamination on both lens surfaces. The upper face of the lens (5) is coated with a lacquer layer (2), which, in turn is coated with a photocatalytic self-cleaning coating (6).

FIG. 14. One surface solution of the optical product in the planar workpiece of the invention. The actual lens (5) (optionally the screen shield) has LGP plates previously produced either by injection moulding or lamination on both lens surfaces. The upper face of the lens (5) is coated with a lacquer layer (2), which, in turn is coated with a coating (6) providing UV protection.

FIG. 15. One surface solution of the optical product in the planar workpiece of the invention. The actual lens (1) (optionally the screen shield) has LGP plates previously produced either by injection moulding or lamination on both lens surfaces. The lower face of the lens (5) is coated with a lacquer layer (2). The first layer on the lens is an antireflective coating (8), which, in turn is coated with a diamond plate (3).

FIG. 16. One surface solution of the optical product in the planar workpiece of the invention. The actual lens (1) (optionally the screen shield) has LGP plates previously produced either by injection moulding or lamination on both lens surfaces. The lower face of the lens (5) is first coated with a lacquer layer (2), which, in turn is coated with an antireflective coating (8). The upper face of the lens is coated with an anti-reflective coating.

FIG. 17. One surface solution of the optical product in the planar workpiece of the invention. In this embodiment of the invention, the lens (4) (optionally the screen shield) has no LGP plate. The upper face of the lens is first coated with an anti-reflective coating, which is in turn coated with a lacquer coating.

### DETAILED DESCRIPTION OF THE INVENTION

The invention relates to a workpiece comprising one or more detachable optical products, the workpiece comprising the optical product integrated without seams being coated with one or more coatings so that at least the uppermost coating of the coated workpiece has a hardness of at least 2 on the Mohs scale of hardness.

The surface of an optical product should preferably have maximal scratch resistance. For this reason, the uppermost coating of a workpiece comprising one or more optical products should preferably have maximal hardness. One way of expressing the surface hardness is to indicate the hardness on the Mohs scale. On the Mohs scale, the numeric value one corresponds to the hardness of talcum, two to that of gypsum, three to that of calcite, four to that of fluorite, five to that of apatite, six to that of orthoclase, seven to that of quartz, eight to that of topaz, nine to that of corundum and ten to that of diamond. The uppermost coating of a workpiece comprising one or more optical products preferably has a hardness of at least 4, most advantageously 6 on the Mohs scale.

The coatings formed on the workpiece preferably extend over the entire workpiece, but can optionally cover the workpiece only partially. In one embodiment of the invention, the workpiece is coated at least at the locations of the optical products. Such partial coating can be produced by means of masks, for instance. The coating formed on the workpiece can be provided on all the faces of the workpiece or only on the desired faces, e.g. both on the upper and the lower surface, or only on either of these. The lateral sides of the workpiece can also be coated.

The workpiece can be made of plastic or glass. Plastic implies any plastic suitable for optical products and glass implies such glass that can be moulded in a molten state, e.g. by injection-moulding. Polycarbonate (PC), which is used also in the production of CD/DVD discs, is one advantageous plastic material.

The workpiece of the invention comprising one or more detachable optical products has a thickness in the range 0.3 mm-5 mm, preferably 0.4 mm-1.5 mm, and most advantageously 0.7 mm-1.2 mm. The workpiece is preferably planar.

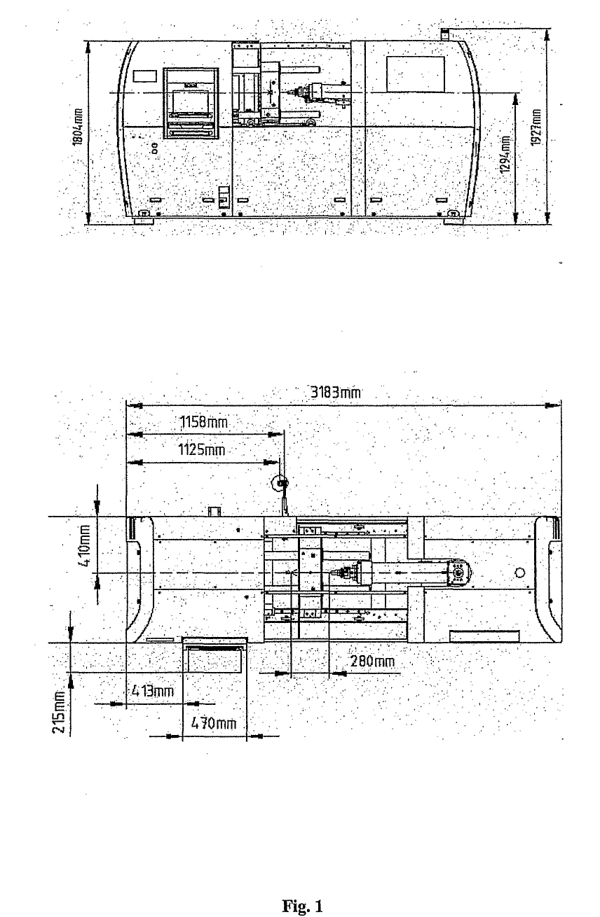

In one preferred embodiment of the invention, the workpiece to be coated is made by injection moulding, preferably using the same injection-moulding installation as those used for manufacturing CD/DVD discs. FIG. 1 illustrates one such conventional injection-moulding apparatus. The workpiece to be produced by injection moulding can have a circular, oval, triangular or polygonal shape, preferably circular. The size of the workpiece of the invention should not be restricted. In one preferred embodiment, however, is has the size of a present CD disc, i.e. a diameter of 120 mm. In a second preferred embodiment of the invention, the workpiece is still circular, but its diameter is 170 mm. The workpiece of both the embodiments can consequently be manufactured either by using the apparatus used for injection moulding of present CD/DVD discs as such or by modifying the equipment.

An uncoated workpiece of the invention can also be produced by cold and hot plastic moulding methods and plastic dead mould casting methods. Other methods readily applicable in this conjunction comprise e.g. pressure casting and moulding presently used for metal moulding.

The workpiece of the invention hence comprises one or more detachable optical products integrated without seams. The optical product can be the planar lens or the screen shield of a telecommunication device, a camera, a GPS positioning device, a consumer electronics device, preferably a telecommunication device.

The workpiece of the invention is coated with one or more coatings. In one embodiment of the invention, one or more lacquer layers have been applied to the surface of the workpiece. Such a surface is preferably an anti-scratch coating of hard lacquer. The lacquer coating can be provided in order to act as a kind of mediator for forming a surface structure. In other words, using a lacquer coating, one can place two coatings on top of each other, whereas the coatings without this intermediate layer would not have adequate interaction for forming a surface structure with sufficient resistance.

The lacquer coating formed on the surface of the workpiece has a thickness in the range 750 nm-50 μm, preferably 1 μm-15 μm and most advantageously 4 μm-7 μm. The lacquer material is preferably the same plastic that is commonly used for coating plastic materials such as CD/DVD discs and spectacles, for instance. The lacquer coating has been produced on the surface of the workpiece by similar conventional methods for producing a lacquer coating. Such methods comprise immersion, sputtering and spin coating.

The workpiece of the invention may also have one or more metal plates for differentiating the optical product. Such a plate does not cover the optical product entirely, and partial metal painting can be provided e.g. by using a mask. Consequently, it may consist of merely a decorative frame pattern made of metal on the screen shield of a mobile phone, or a text for profiling the product.

In one embodiment of the invention, one or more metal plates formed on the workpiece have been provided by evaporating metal with laser ablation, so that the generated material plasma is oriented to the surface of the workpiece, thus forming a metal plate. The metal plate can also be produced by other more conventional means, such as tampo printing, piezo spraying or a TS film.

Ornamental 4-colour prints can also be made on the surface of the workpiece for differentiated optical products.

The workpiece of the invention may further comprise one or more diamond plates. As mentioned above, the hardness of diamond is 10 on the Mohs scale. Such a surface is practically scratch proof and also resists e.g. chemicals causing corrosion. The diamond plate formed on the surface of the workpiece has a thickness in the range 1 nm-3 μm, preferably 20 nm-500 nm and most advantageously 30 nm-300 nm.

The diamond plate may consist of ordinary diamond like carbon DLC, ta-C not containing hydrogen, or diamond having a very high sp3 bond proportion. Even though a synthetic diamond plate cannot be given an explicit definition, it should not be restricted to the definitions given here.

In one embodiment of the invention, one or more diamond plates have been formed on the workpiece by evaporating carbon with laser ablation, the material plasma thus produced being oriented to the surface of the workpiece, forming a diamond layer.

The workpiece of the invention may further comprise one or more photocatalytic coatings. If the workpiece is provided with a photocatalytic coating, such a coating is preferably the uppermost coating of the workpiece and hence also of the optical products in this. Such a photocatalytic coating is self-cleaning, in other words, the photocatalytic material decomposes any organic impurities present on the surface of the workpiece and the optical product under the catalytic action of the UV radiation of light.

In one embodiment of the invention, one or more photocatalytic coatings have been formed on the workpiece by evaporating the necessary metal oxide using laser ablation, so that the material plasma thus produced is oriented to the surface of the workpiece, thus forming a photocatalytic layer.

In a second embodiment of the invention, one or more photocatalytic coatings have been formed on the workpiece by evaporating the necessary metal oxide using laser ablation in the oxygen phase, the material plasma thus generated being oriented to the surface of the workpiece, forming a photocatalytic layer.

The following are examples of metals necessary for forming a photocatalytic coating: titanium, zinc, silver, iron, copper, wolfram, silica, molybdenum, strontium or alloys of these.

If the workpiece has a photocatalytic coating, this coating has a thickness in the range 1 nm-1000 nm, preferably 5 nm-200 nm and most advantageously 20 nm-50 nm.

In one further embodiment of the invention, one or more coatings producing UV protection may have been formed on the surface of the workpiece. Such a coating providing UV protection can be produced by evaporation of a necessary substrate with laser ablation, the material plasma thus produced being oriented to the surface of the workpiece, forming a layer providing UV protection.

If a surface providing UV protection has been formed on the surface of the workpiece, this surface has a thickness in the range 1 nm-1000 nm, preferably 5 nm-200 nm and most advantageously 20 nm-50 nm.

The workpiece of the invention comprising one or more detachable optical products has been provided with one or more Light Guiding Plates LGP. Such a microprisma layer guides the light penetrating through the lens or the screen shield to the side so that it does not reach the LCD display of say, a mobile phone or any similar product.

In one preferred embodiment, the LGP plate has been formed during the actual injection-moulding process of the workpiece. In a second preferred embodiment of the invention, the LGP plate has been formed by lamination.

The workpiece of the invention and especially its optical products have preferably been provided with one or more anti-reflective coatings. Such coatings are frequently used for coating optical lenses and screen shields. The function of an anti-reflective coating is based on the utilisation of interference, i.e. interacting light beams which either reinforce or attenuate each other. In an anti-reflective coating, it is desirable to extinguish the reflective light beams, and this happens when the coating film is thin enough (lambda/4) and the coating material has a specific refraction index. It is impossible to achieve a 100% antireflective coating, so that the lens will still reflect a given colour shade. The thickness of the films and the colour of the residual reflex can be varied according to the purpose of use.

The optical products can be detached from the workpiece of the invention comprising one or more detachable optical products integrated without seams preferably by water abrasion, laser cutting, a miller or a saw. The optical products can further be removed using e.g. laser cutting.

If the coating has been formed on the workpiece by laser ablation, this has preferably been done by means of pulsed laser. Such a pulsed laser is preferably a cold-working laser, such as a picosecond or phemtosecond laser. Laser ablation is preferably carried out under vacuum, e.g. in a vacuum chamber as the one described in FI Patent Application 20050558 and utilising a material plasma fan as the one described in FI Patent Application 20050559. Under constant air pressure, impurities in the air will generate contamination and affect the quality of the coatings formed on the end product. Without vacuum conditions, a major portion of the laser effect would be wasted.

The invention also relates to a method for manufacturing a workpiece comprising one or more detachable optical products by producing a workpiece comprising an optical product integrated without seams and by coating the workpiece with one or more plates, at least the uppermost plate of the coated workpiece having a hardness of at least 2 on the Mohs scale.

The plates formed on the surface of the workpiece to be manufactured extend preferably over the entire workpiece, but they could also cover the workpiece only partially. In one embodiment of the invention, the workpiece is in fact coated only at the locations of the optical products. Then partial coating can be performed e.g. by using masks. Plates can be produced on all the surfaces of the workpiece or only on the desired ones, such as on the upper and lower surfaces alone, or on either of these. The method also allows for coating of the lateral sides of the workpiece.

In accordance with the method, the workpiece can be made of plastic or glass. Plastic denotes any plastic suitable for optical products and glass, in turn, denotes glass that can be moulded in a molten state, using injection moulding, for instance. One preferred plastic material is polycarbonate (PC), which is used in the manufacture of CD/DVD discs as well.

In the method of the invention, the workpiece comprising one or more detachable optical products has a thickness in the range 0.3 mm-5 mm, preferably in the range 0.4 mm-1.5 mm, and most advantageously in the range 0.7 mm-1.2 mm.

In one preferred embodiment of the invention, the workpiece to be coated is produced by injection moulding, using preferably the same injection-moulding apparatus as those used in the manufacture of CD/DVD discs. FIG. 1 illustrates one such conventional injection-moulding apparatus. A workpiece that is produced by injection moulding may be circular, oval, triangular or polygonal, preferably it is made with a circular shape. The size of the workpiece produced with the method of the invention should not be restricted. In one preferred embodiment, the workpiece is made in the same size as current CD discs, having a diameter of 120 mm. In a second preferred embodiment of the invention, the workpiece is also made with a circular shape, but with a diameter of 170 mm. This means that both the embodiments allow manufacture of the workpiece either using the injection-moulding apparatus used for manufacturing current CD/DVD discs as such or in a modified version.

Consequently, the workpiece made by the method of the invention comprises one or more detachable optical products integrated without seams. The optical product may be a planar lens or screen shield in a telecommunication device, a camera, a GPS positioning device, a consumer electronics device, preferably a telecommunication device.

The workpiece made by the method of the invention is coated with one or more coatings. In one embodiment of the invention, the workpiece surface is provided with one or more lacquer coatings. Such a coating is preferably an anti-scratch hard lacquer coating. A lacquer coating can also be provided to act as a kind of mediator for forming the surface structure. In other words, using a lacquer coating, it is possible to place two coatings on top of each other, which, without such a lacquer coating, would not have adequate interaction to form a surface structure with sufficient resistance.

The lacquer coating formed on the surface of the workpiece has a thickness in the range 750 nm-50 μm, preferably in the range 1 μm-15 μm, and most advantageously in the range 4 μm-7 μm. The lacquer material is preferably the same plastic as is commonly used for coating CD/DVD discs and spectacles, for instance. The lacquer coating is produced on the surface of the workpiece with similar commonly used methods for producing a lacquer coating. Such methods comprise e.g. immersion, sputtering and spin coating.

The workpiece made by the method of the invention may also comprise one or more metal plates for individualising the optical product. Such a plate does not cover the optical product entirely, a partial metal paint being provided by using a mask, for instance. The plate may thus consist of an ornamental frame pattern of metal framing an optical product such as the screen shield of a mobile phone or a text for profiling the product.

In one embodiment of the method of the invention, one or more metal plates on the workpiece are produced by evaporating metal by means of laser ablation, so that the material plasma thus produced is oriented to the surface of the workpiece and forms a metal plate on this. A metal plate can also be produced by other ordinary means, such as tampo printing or a TS film.

The workpiece surface can also be provided with ornamental four-colour prints for differentiating the product.

It is also possible to produce one or more diamond plates on the workpiece by using the method of the invention. The diamond plate produced on the workpiece surface has a thickness in the range 1 nm-3 μm, preferably in the range 20 nm-500 nm and most advantageously in the range 30 nm-300 nm.

The diamond plate may consist of ordinary diamond-like carbon (DLC), ta-C not containing hydrogen, or a diamond having a very high sp3 bond proportion. Even though there is no explicit definition of a synthetic diamond plate, it should not, however, be restricted to the definitions mentioned above.

In one embodiment of the invention, one or more diamond plates are produced on the workpiece by evaporating carbon with laser ablation, so that the material plasma thus produced is oriented to the surface of the workpiece, forming a diamond layer on this.

In addition, one or more photocatalytic layers can be provided on the workpiece made by the method of the invention. If a photocatalytic layer is produced on the workpiece, it is placed as the uppermost layer of the workpiece and hence also of the optical products in this. Such a photocatalytic layer is an auto-cleaning surface, in other words, the photocatalytic material decomposes any organic impurities present on the surface of the workpiece and the optical product under the catalytic action of the UV radiation of light.

In one embodiment of the invention, one or more photocatalytic layers are formed on the workpiece by evaporating the required metal oxide by laser ablation, so that the material plasma thus produced is oriented to the surface of the workpiece, forming a photocatalytic layer.

In a second embodiment of the invention, one or more photocatalytic layers are formed on the workpiece by evaporating the required metal by laser ablation in the oxygen phase, so that the material plasma thus produced is oriented to the surface of the workpiece, forming a photocatalytic layer.

Examples of metals required to form a photocatalytic plate in the method comprise titanium, zinc, silver, iron, copper, wolfram, silica, molybdenum, strontium or alloys of these.

If a photocatalytic layer is produced on the workpiece, this layer is formed with a thickness in the range 1 nm-1000 nm, preferably 5 nm-200 nm and most advantageously 20 nm-50 nm.

In a further embodiment of the invention, the workpiece can be coated with one or more layers providing UV protection. Such a layer providing UV protection can be formed by evaporation of the necessary substrate by means of laser ablation, so that the material plasma thus produced is oriented to the workpiece surface and forms a layer producing UV protection on this.

If the workpiece surface is provided with a surface layer providing UV protection, this layer is produced with a thickness in the range 1 nm-1000 nm, preferably 5 nm-200 nm, and most advantageously 20 nm-50 nm.

In the method of the invention, the workpiece comprising one or more detachable optical products is provided preferably with one or more light guiding plates (LGP). Such a micro-prisma layer orients the light penetrating through a lens or a screen shield to the side, preventing it from reaching the LCD display of a mobile phone or a similar product.

In one preferred embodiment of the method of the invention, the LGP is formed in the actual injection-moulding step of the workpiece. In a second preferred embodiment of the method of the invention, the LGP is produced by lamination.

The method of the invention also preferably comprises the formation of one or more anti-reflective layers on the workpiece and especially on the optical products comprised in this.

The method of the invention allows the one or more optical products to be detached from the workpiece comprising these products integrated without seams preferably by using water abrasion, laser cutting, a miller or a saw. The optical products can also be detached using e.g. laser cutting. The coated workpiece containing the finished optical products can also be taken to an apparatus for further processing as such. In this case, one can remove the optical products from the workpiece only at the object of use in order to obtain cost efficiency and to avoid supplementary steps for packaging and unpacking individual optical products.

If the layer is produced on the workpiece by laser ablation, laser ablation is preferably performed by means of pulsing laser. Such a pulsing laser is preferably a cool-working laser, such as a picosecond or phemtosecond laser. Laser ablation is preferably carried out under vacuum, e.g. in a vacuum chamber as the one described in FI Patent Application 20050558, utilising a material plasma fan as the one described in FI Patent Application 20050559.

High-quality lenses and screen shields typically have a very smooth surface, which is free from white and black impurities, stresses and aurea borealis. Also, any colour prints, metal plates, holograms and other differentiating details provided on these are flawless and placed at the exactly correct position, so that the display area proper will still be flawless after all the working process steps have been performed. They should be scratch proof, choc resistant, resistant to contamination and chemicals, anti-reflective and highly translucent. They could also possess other features, such as self-cleaning, UV protection and a touch-sensitive display based on an active matrix. Hard lacquer coatings and diamond coatings are examples of preferred anti-scratch coatings.

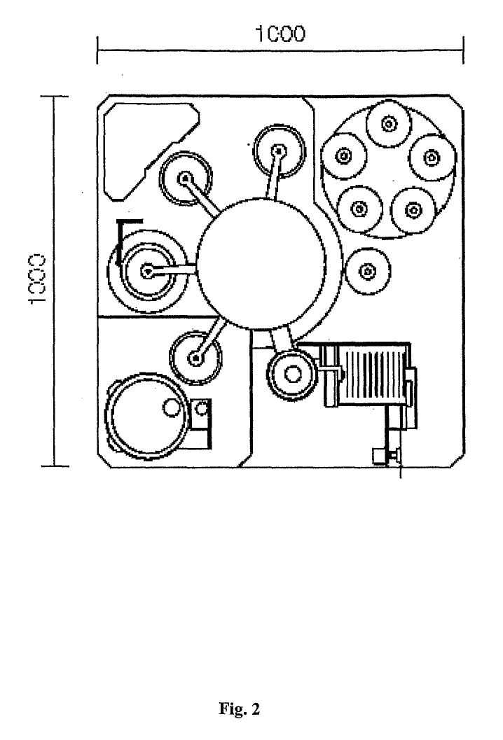

Some embodiments of the invention allow for the workpiece provided with the surface properties mentioned above and comprising one or more optical products integrated without seams and for the method for producing it. Such a workpiece is preferably produced using the apparatus (FIG. 1) currently available on the market for producing CD/DVD discs, with an uncoated workpiece injection moulded in an injection-moulding unit and the coatings of the workpiece, together with the coatings of all the optical products in the workpiece, being performed in a coating unit integrated in this injection-moulding unit or in laser ablation units. The coating unit may consist of say, a coating unit used in the manufacture of CD/CDV discs, as illustrated in FIG. 2. The workpiece of the invention can also be moulded in other injection-moulding installations made for this purpose, and the coating steps can also be performed separately using coating units specially devised for this purpose.

Given the easily controlled thickness and smooth surface of coatings made in this manner, optical products produced in this manner will have excellent final properties.

Some embodiments of the invention allow for an initial workpiece shape identical to that of a 120 mm CD disc, and then it is particularly easy and advantageous to use e.g. the same productions lines as those used for CD/DVD discs for manufacturing the workpieces of the invention. Some other embodiments of the invention, again, allow the size of the workpiece of the type of a CD disc to be increased to 170 mm, for instance. In this case, the same workpiece will accommodate an even larger number of optical products, which can further be coated with high efficiency and quality, and even more economically in mutually integrated working modules. Consequently, the size, thickness and shape of the workpiece can be adapted to the requirements of use in each case.

Integration of the different production units allows for flawless and above all, rapid production. A plurality of optical products are simultaneously produced and worked with homogenous quality and by economical means in the same work steps. The end product thus obtained will be a workpiece comprising optical products that can be sold as such for further application.

The actual injection-moulding process, which is hence performed economically and using the same installations as those available for producing CD/DVD discs, comprises central injection moulding, while the molten plastic or glass material moves on the outer periphery, the workpiece thus produced forming a large, intact and planar surface.

When using e.g. plastic as the raw material, the “primary plastic”, i.e. the plastic initially in contact with the mould surface, moves to the outer periphery of the mould. Such primary plastic originating from the ducts of a needle valve never has high quality, and it then advantageously moves to the outer periphery, and not to areas of the workpiece where the optical products of the workpiece will be located.

Injection moulding can be carried out in a kind of basic mould having e.g. the size of a CD/DVD disc and a thickness of 20-50 mm. The mould block is the surface on which a product-specific coating, logo, text or LGP can be placed. This mould block is part of the mould, and when a new product is produced, one only has to replace the mould block. The block proper can be an integrated part of the injection-moulding machine, comprising stationary ejection means and water-cooling means. Compared to previous methods, it is no longer necessary to use a separate, product-specific mould cavity and a separate complete mould for each product. Since the product is now produced in the same mould, there is no need to change the parameters of the injection-moulding machine. This procedure speeds up the production and decreases the production costs of the individual products. It also allows the thickness of the lenses and screen shields of the invention to be reduced without jeopardising the quality and/or operating characteristics of the optical product.

Besides being rapid, coating a workpiece together with its optical products in a coating unit integrated in an injection-moulding apparatus also ensures high quality of the functional coatings in the production of the present products. Since the coating units are modules, such as e.g. the units of an installation for coating CD discs as disclosed by US Patent Application 2002/0067978, or cool-working laser units as those disclosed by FI Patent Applications 20050559 and 20050558, a combination of these modules will readily provide the device assembly required for producing the coating configuration desired in each case. Part of the coatings can be produced using standard coating units used in CD installations, and part of them using both these and laser units, and part of them using laser units alone.

### EXAMPLES

The following is a description of a workpiece of the invention and a method for producing it, yet without restricting the invention to the examples given here. The lens/screen shield blanks described in the examples may be made either of plastic or glass.

### Example 1

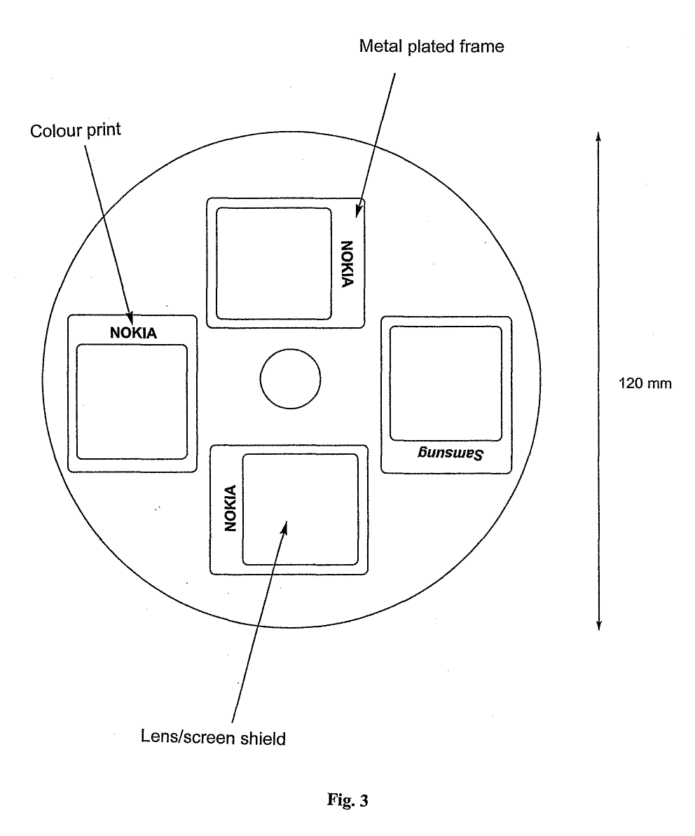

The workpiece produced in example is illustrated in FIG. 3.

The workpiece of example 1 has been produced using installations intended for producing CD/DVD discs as illustrated in FIGS. 1 and 2 and a pulsing laser of the company Corelase Oy. The workpiece has four integrated optical products, which can be removed from the workpiece by cutting with conventional methods. The workpiece has a diameter of 120 mm and a thickness of 0.9 mm. The workpiece is made of polycarbonate. The workpiece comprises an LGP already produced in the injection-moulding step, which hence are provided in all the optical products contained in the workpiece.

A lacquer layer has been provided on both sides of the uncoated workpiece blank using conventional CD disc techniques in the module illustrated in FIG. 2. The other surface of the workpiece has been coated (the uppermost surface of the future optical product) with a titanium dioxide layer using laser ablation (pulse duration 30 ps, repetition frequency 20 MHz and pulse power 5 μJ). The titanium dioxide layer thus formed has a thickness of approximately 30 nm and the coating was formed under 10⁻⁴ Torr vacuum.

The metal plates and colour prints were made using conventional methods in the modules of FIG. 2.

### Example 2

The workpiece produced in example 2 is illustrated in FIG. 4. The workpiece is identical to that of example 1, however, this example illustrates the lines for cutting the planar lenses/screen shields contained in the workpiece. The optical product can preferably be detached from the workpiece by water abrasion. The cutting unit can be an integrated part of the production plant, or the workpiece can be delivered/sold as such for further processing.

### Example 3

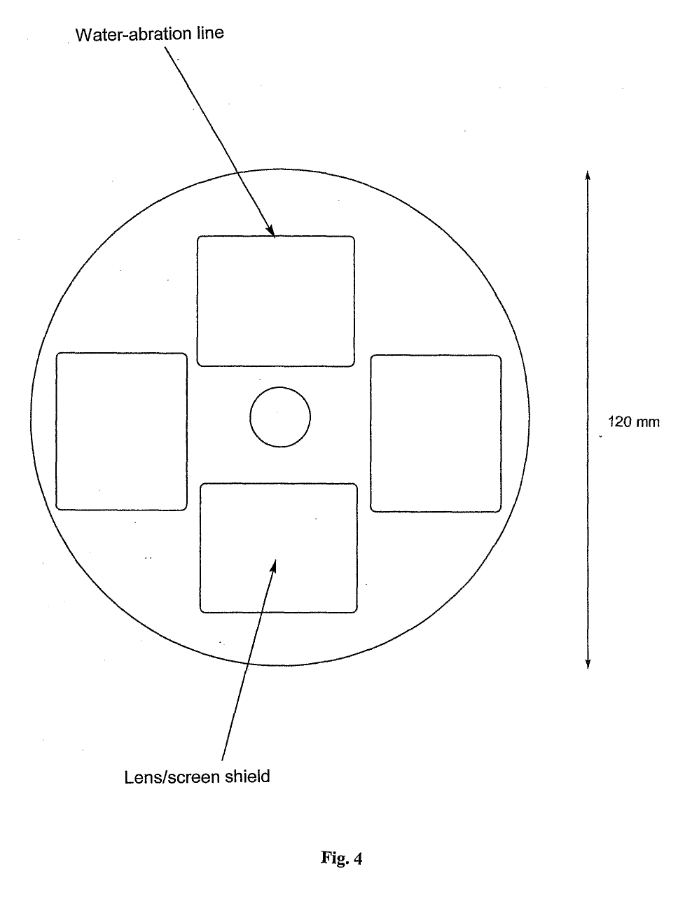

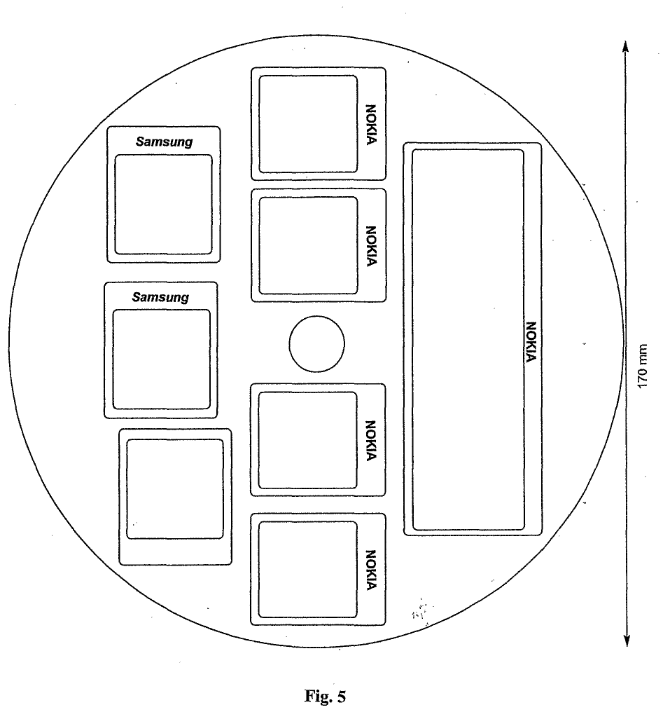

The workpiece of the invention exemplified by example 3 is illustrated in FIG. 5. The workpiece has a diameter of 170 mm and a thickness of 0.8 mm. The workpiece comprises a plurality of different lenses and/or screen shields and it is made of polycarbonate. The upper and lower surfaces of the workpiece have been made by lamination of light guide plates. In addition, the second surface of the workpiece (the upper side of the future optical product) has a conventional anti-reflective coating. The uppermost surface of the workpiece consists of a diamond layer produced by laser ablation using the installation and the parameters mentioned in example 1, and it has a thickness of approximately 150 nm.

### Example 4

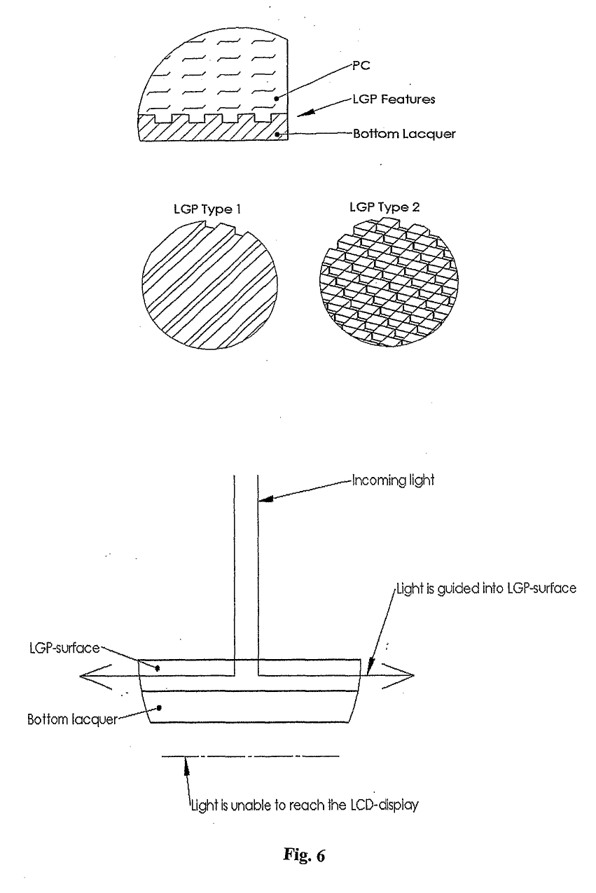

The workpiece of the invention exemplified by example 4 is illustrated in FIG. 6. Light guide plates can be produced both during the injection moulding of the workpiece and by laminating. There are several pattern options. Two of these are illustrated in FIG. 6. These surface structures will orient the light incident from above the lens/screen shield in parallel with the light guide plate, thus blocking off the light substantially from the surface of a light guide plate located under such an optical product.

### Example 5

The surface structures of the optical product can be produced in accordance with the invention with the desired thicknesses and in the desired mutual order depending on the purpose of use of the optical product. This example (FIG. 7) illustrates the surface solution of a workpiece and of an optical product, in which the actual lens (1) (optionally the screen shield) comprises a light guide plate previously produced either by injection moulding or lamination. The lower and upper side of the lens is coated with a lacquer coating (2). The lacquer coating preferably consists of hard lacquer. In this surface solution, and also in all the following ones, the coatings are shown with an intermediate space. This has been done with the purpose to illustrate the coatings, in other words, the coatings illustrated here are in mutual contact in reality.

### Example 6

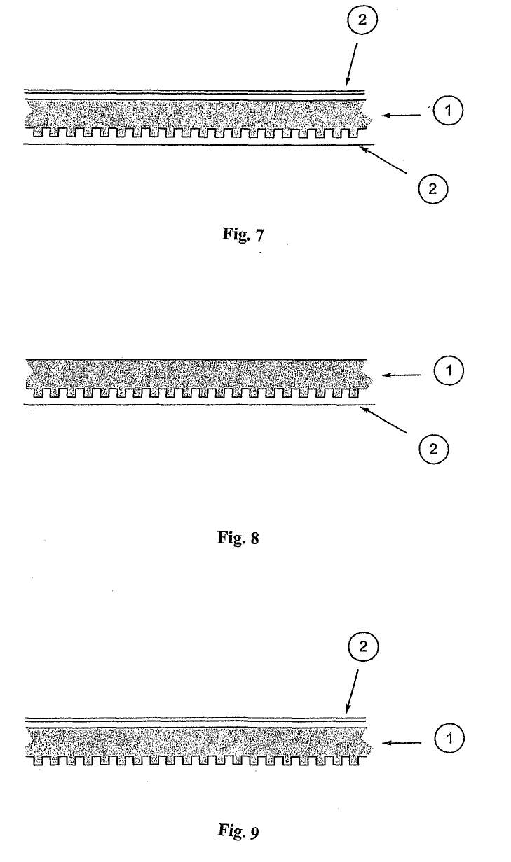

This example (FIG. 8) illustrates the surface solution of a workpiece and hence of an optical product in which the lens itself (1) (optionally the screen shield) has a light guide plate previously produced by injection moulding or lamination. The lacquer coating (2) is provided on the lower surface of the lens alone.

### Example 7

This example (FIG. 9) illustrates the surface solution of a workpiece and hence of an optical product in which the lens itself (1) (optionally the screen shield) has a light guide plate previously produced by injection moulding or lamination. The lacquer coating (2) is provided on the upper surface of the lens alone.

### Example 8

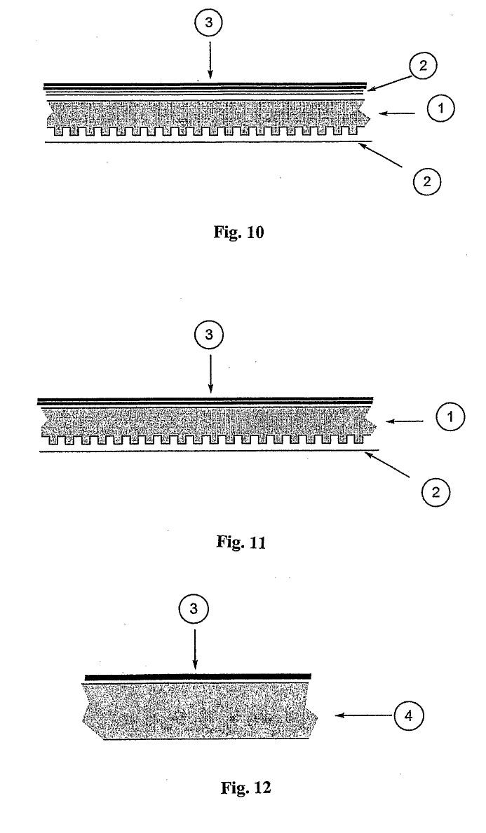

This example (FIG. 10) illustrates the surface solution of a workpiece and hence of an optical product in which the lens itself (1) (optionally the screen shield) has a light guide plate previously produced by injection moulding or lamination. A lacquer coating (2) is provided on the lower surface and the upper surface of the lens. In this embodiment of the invention, the uppermost coating of the optical product consists of a diamond layer (3).

### Example 9

This example (FIG. 11) illustrates the surface solution of a workpiece and hence of an optical product in which the lens itself (1) (optionally the screen shield) has a light guide plate previously produced by injection moulding or lamination. A lacquer coating (2) is provided on the lower surface of the lens and a diamond coating (3) is provided in the upper surface of the lens.

### Example 10

This example (FIG. 12) illustrates the surface solution of a workpiece and hence of an optical product in which the lens (4) (optionally the screen shield) is not provided with a light guide plate. The lens is coated with a diamond layer (3).

### Example 11

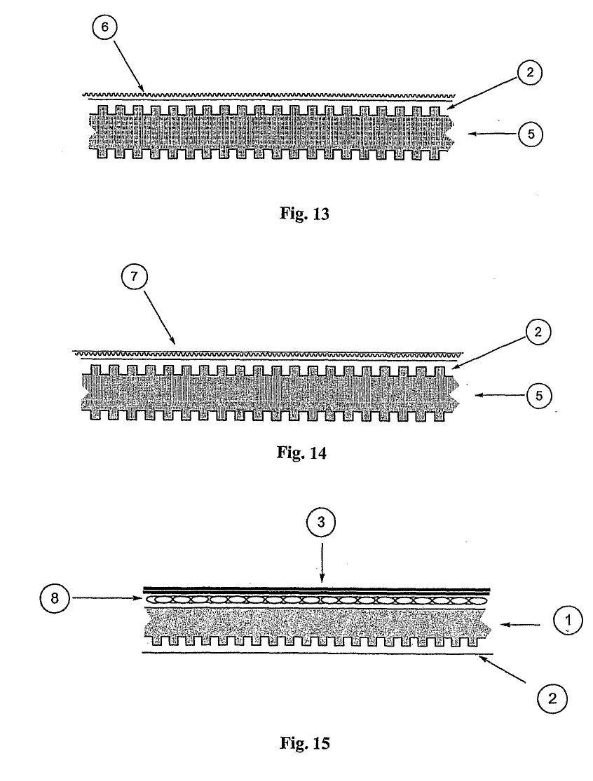

This example (FIG. 13) illustrates the surface solution of a workpiece and hence of an optical product in which the lens itself (5) (optionally the screen shield) has light guide plates previously produced by injection moulding or lamination on both sides of the lens. A lacquer coating (2) is provided on the upper surface of the lens (5), and this coating is further coated with a photocatalytic self-cleaning layer (6).

### Example 12

This example (FIG. 14) illustrates the surface solution of a workpiece and hence of an optical product in which the lens itself (5) (optionally the screen shield) has light guide plates previously produced by injection moulding or lamination on both sides of the lens. A lacquer coating (2) is provided on the upper surface of the lens (5), and this coating is further coated with a photocatalytic self-cleaning layer (6).

### Example 13

This example (FIG. 15) illustrates the surface solution of a workpiece and hence of an optical product in which the lens itself (1) (optionally the screen shield) has a light guide plate previously produced by injection moulding or lamination. A lacquer coating (2) is provided on the lower surface of the lens. The first coating on the lens is an anti-reflective coating (8). This coating is further coated with a diamond layer (3).

### Example 14

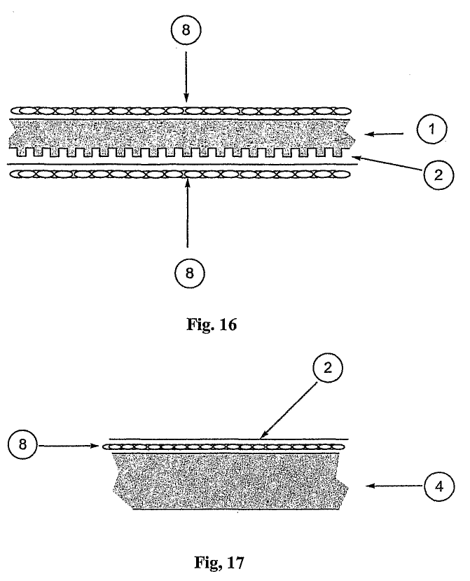

This example (FIG. 16) illustrates the surface solution of a workpiece and hence of an optical product in which the lens itself (1) (optionally the screen shield) has a light guide plate previously produced by injection moulding or lamination. A lacquer coating (2) is provided on the lower surface of the lens, this coating being followed by an anti-reflective layer (8). The upper side of the lens is coated with an anti-reflective coating.

### Example 15

This example (FIG. 17) illustrates the surface solution of a workpiece and hence of an optical product in which the lens (4) (optionally the screen shield) is not coated with a light guide plate. The upper side of the lens is coated with an anti-reflective coating, which, in turn, is coated with a lacquer layer.

1-60. (canceled)

61. A workpiece comprising one or more detachable optical products, wherein the workpiece comprising the optical product integrated without seams is coated with one or more coatings, so that at least the uppermost coating of the coated workpiece has a hardness of at least 2 on the Mohs scale of hardness, characterised in that one or more coatings have been formed by evaporating hard coating by means of laser ablation, the material plasma thus formed being oriented to the surface of the workpiece, thus producing a hard coating plate.

62. A workpiece as defined in claim 61, characterised in that the surface of the workpiece has been coated with one or more diamond layers.

63. A workpiece as defined in claim 62, characterised in that the diamond layer has a thickness in the range 1 nm-3 μm, preferably 20 nm-500 nm and most advantageously 30 nm-300 nm.

64. A workpiece as defined in claim 62, characterised in that one or more diamond layers have been formed by evaporating carbon by means of laser ablation, the material plasma thus formed being oriented to the surface of the workpiece, thus producing a diamond layer.

65. A workpiece as defined in claim 61, characterised in that the surface of the workpiece has been coated with one or more photocatalytic layers.

66. A workpiece as defined in claim 65, characterised in that one or more photocatalytic layers have been formed by evaporating the necessary metal oxide by means of laser ablation, the material plasma thus formed being oriented to the surface of the workpiece, thus producing a photocatalytic layer.

67. A workpiece as defined in claim 65, characterised in that one or more photocatalytic layers have been formed by evaporating the necessary metal by means of laser ablation in the oxygen phase, the material plasma thus formed being oriented to the surface of the workpiece, thus producing a photocatalytic layer.

68. A workpiece as defined in claim 66, characterised in that the metal consists of titanium, zinc, silver, iron, copper, wolfram, silica, molybdenum, strontium or alloys of these.

69. A workpiece as defined in claim 65, characterised in that the photocatalytic layer has a thickness in the range 1 nm-1000 nm, preferably 5 nm-200 nm, and most advantageously 20 nm-50 nm.

70. A workpiece as defined in claim 61, characterised in that one or more layers producing UV protection have been formed by evaporating the necessary substrate by means of laser ablation, the material plasma thus formed being oriented to the surface of the workpiece, thus producing a layer providing UV protection.

71. A workpiece as defined in claim 70, characterised in that the layer providing UV protection has a thickness in the range 1 nm-1000 nm, preferably 5 nm-200 nm and most advantageously 20 nm-50 nm.

72. A workpiece as defined in claim 61, characterised in that the surface of the workpiece has been coated with one or more light guide plates (LGP).

73. A workpiece as defined in claim 72, characterised in that the light guide plate has been produced during the injection moulding of the workpiece.

74. A workpiece as defined in claim 72, characterised in that the light guide plate has been produced by lamination.

75. A workpiece as defined in claim 61, characterised in that laser ablation is performed by means of pulsing laser.

76. A workpiece as defined in claim 75, characterised in that the pulsing laser is a cold-working laser, such as a picosecond or phemtosecond laser.

77. A method for producing a workpiece comprising one or more detachable optical products, wherein a workpiece comprising one or more optical products integrated without seams is produced and coated with one or more coatings, at least the uppermost coating of the coated workpiece having a hardness of at least 2 on the Mohs scale of hardness, characterised in that one or more coatings have been formed by evaporating hard coating by means of laser ablation, the material plasma thus formed being oriented to the surface of the workpiece, thus producing a hard coating plate.

78. A method as defined in claim 77, characterised in that the surface of the workpiece has been coated with one or more diamond layers.

79. A method as defined in claim 78, characterised in that the diamond layer has a thickness in the range 1 nm-3 μm, preferably 20 nm-500 nm, and most advantageously 30 nm-300 nm.

80. A method as defined in claim 78, characterised in that one or more diamond layers have been formed by evaporating carbon by means of laser ablation, the material plasma thus formed being oriented to the surface of the workpiece, thus producing a diamond layer.

81. A method as defined in claim 77, characterised in that the surface of the workpiece has been coated with one or more photocatalytic layers.

82. A method as defined in claim 81, characterised in that one or more photocatalytic layers have been formed by evaporating the necessary metal oxide by means of laser ablation, the material plasma thus formed being oriented to the surface of the workpiece, thus producing a photocatalytic layer.

83. A method as defined in claim 81, characterised in that one or more photocatalytic layers have been formed by evaporating the necessary metal by means of laser ablation in the oxygen phase, the material plasma thus formed being oriented to the surface of the workpiece, thus producing a photocatalytic layer.

84. A method as defined in claim 82, characterised in that the metal consists of titanium, zinc, silver, iron, copper, wolfram, silica, molybdenum, strontium or alloys of these.

85. A method as defined in claim 81, characterised in that the photocatalytic layer has a thickness in the range 1 nm-1000 nm, preferably 5 nm-200 nm and most advantageously 20 nm-50 nm.

86. A method as defined in claim 77, characterised in that one or more layers producing UV protection have been formed by evaporating the necessary substrate by means of laser ablation, the material plasma thus formed being oriented to the surface of the workpiece, thus producing a layer providing UV protection.

87. A method as defined in claim 77, characterised in that the layer providing UV protection has a thickness in the range 1 nm-1000 nm, preferably 5 nm-200 nm and most advantageously 20 nm-50 nm.

88. A method as defined in claim 77, characterised in that the surface of the workpiece has been coated with one or more light guide plates.

89. A method as defined in claim 88, characterised in that the light guide plate has been produced during the injection moulding of the workpiece.

90. A method as defined in claim 88, characterised in that the light guide plate has been produced by lamination.

91. A method as defined in claim 77, characterised in that laser ablation is performed by means of pulsing laser.

92. A method as defined in claim 91, characterised in that the pulsing laser is a cold-working laser, such as a picosecond or phemtosecond laser.
